(19) United States
(12) Patent Application Publication
(10) Pub. No.: US 2026/0264650 A1
(43) Pub. Date: Sep. 10, 2026

(54) DYNAMIC BRAKING ON THREE WHEELS

(71) Applicants: ASTEMO France, Drancy (FR); Astemo Heilbronn GmbH, Heilbronn (DE)

(72) Inventors: Julien SASSO, CHAMPS SUR MARNE (FR); Weiqiao WANG, PARIS (FR); Alex PATRAO CARQUEIJO, PANTIN (FR); Maxime DEMANDRE, STUTTGART (DE)

(21) Appl. No.: 19/165,647

(22) PCT Filed: Mar. 14, 2024
(86) PCT No.: PCT/EP2024/056765

§ 371 Date: Sep. 16, 2025

(30) Foreign Application Priority Data
Mar. 17, 2023 (FR) FR2302479

(51) Int. Cl. B60T 8/1761

(52) U.S. Cl. CPC B60T 8/1761; B60T 2270/10; B60T 2270/402; B60T 2270/403

(57) ABSTRACT

A method and system for emergency braking of a vehicle rear wheel equipped with an electric parking brake, by implementing either an anti-lock braking mode or an incremental braking mode. When the speeds of two front wheels are not known but only one is known, the anti-lock braking mode is applied with, as reference speed, this known speed, corrected by a reducing operation, and when the speed of no front wheel is known, the incremental braking mode is applied. A vehicle equipped with such a system.

### FIELD OF THE INVENTION

The present invention relates to the technical field of electric parking brakes and in particular to the field of using electric parking brakes during emergency braking.

### BACKGROUND

As described in document U.S. Pat. No. 7,744,166, a parking brake is implemented electrically and/or automatically by an electromechanical unit, also called electric actuator, associated with one or more of the vehicle wheels. Thus, a user of the vehicle wishing to engage the parking brake simply needs to press a push button, located for example on the dashboard near the steering wheel, to trigger or terminate the clamping of the parking brake around the vehicle wheel.

The Rear Wheel Unlocker (RWU) braking mode is already known. It consists in using the parking brake of the rear wheels to dynamically brake the vehicle when the hydraulic system service brakes are faulty. The aim is to apply the brakes of the rear wheels without locking them. More precisely, in case of wheel slipping, the brake is released to unlock the wheel or to avoid locking it, then it is reapplied, etc. This control mode is inspired by the ABS (registered trademark), but differs in that it uses the electric control of the brake motor.

More precisely, the RWU braking mode consists in performing the following operations in a loop:
if the wheel slipping is less than a first predetermined threshold, called the “low threshold”, progressively applying the brake until the slipping becomes greater than this low threshold,
if the slipping is greater than a second predetermined threshold, called the “high threshold”, greater than the low threshold, progressively releasing the brake until the slipping becomes less than this high threshold,
if the slipping is greater than the low threshold and less than the high threshold, maintaining application at its current level.

To determine whether locking occurs, the speed of rotation of the four vehicle wheels must be known. The two front wheels are used to calculate a reference speed, with which the speed of each rear wheel is compared to determine whether this rear wheel is in a locking situation: a speed less than the reference speed by more than the predetermined threshold indicates locking or start of locking. In other words, if the speed is less than the reference speed minus the predetermined threshold, it may be considered that there is locking or start of locking.

If one of the rear wheels no longer supplies its speed of rotation, it is obviously impossible to use the RWU braking mode. In this case, an incremental braking mode must be used, according to which the application of the electric parking brake is increased slightly incrementally at regular intervals, to avoid creating wheel locking conditions, without however being able to check whether or not this locking occurs.

However, if only one of the front wheels no longer supplies its speed of rotation, the anti-lock mode is also unavailable, since the reference speed, which acts as point of comparison for the speed of rotation of each rear wheel, cannot be determined if only the speed of rotation of a single front wheel is known. In fact, when the vehicle follows a curved trajectory, for example when turning, the difference in speed of rotation between the wheels on the inside of the bend and the wheels on the outside of the bend is such that the comparison with the speed of only one of the two front wheels could lead to incorrect conclusions. For example, the speed of a rear wheel on the inside is always less than the speed of a front wheel on the outside. In this case, it may appear as still locked. Inversely, the speed of a rear wheel on the outside is always greater than the speed of a front wheel on the inside. Its speed may be reduced, in other words it may start to lock, without this speed becoming sufficiently less than the speed of the front wheel on the outside. In this case, locking is not detected. Consequently, in the state of the art, if a front wheel no longer supplies its speed of rotation, the anti-lock braking mode is no longer used and is replaced by the incremental mode. Document US2021370899A1 also describes a switch to the electronic parking brake in the event of failure of the braking functions. In addition, document U.S. Pat. No. 6,092,879 describes a solution to neutralise the vehicle anti-lock or braking distributor when a fault is detected. However, none of these known solutions overcomes the problem of a front wheel no longer supplying its speed of rotation.

### SUMMARY OF THE INVENTION

One object of the invention is a method for emergency braking of a vehicle wheel equipped with an electric parking brake, the vehicle having at least two axles and the wheel being on a first of said at least two axles, by implementing either an anti-lock braking mode, or an incremental braking mode, the anti-lock braking mode being provided by controlling the parking brake in compliance with the following rules, whereas the slipping of the wheel is obtained by calculating the difference between the speed of rotation of the wheel and a reference speed obtained using the speed of at least one of the two wheels of a second of said at least two axles of the vehicle:
if the slipping is less than a first predetermined threshold, progressively applying the brake until the slipping becomes greater than this first threshold,
if the slipping is greater than a second predetermined threshold, greater than the first threshold, progressively releasing the brake until the slipping becomes less than this second threshold,
if the slipping is greater than the first threshold and less than the second threshold, maintaining application at its current level,
the incremental braking method being provided by controlling the parking brake by increasing its application in stages of predetermined durations,
   the method being characterised in that, when the speeds of two wheels of the second axle are not known but only one is known, the anti-lock braking mode is applied with, as reference speed, this known speed, corrected by a reducing operation, and when the speed of no wheel on the second axle is known, the incremental braking mode is applied.

In the present description, a dynamic braking request means a braking command actuated by the vehicle driver-human being or artificial intelligence-depending on traffic requirements, while the vehicle is moving.

In the present description, slipping of a wheel means the fact that the speed of translation of the wheel is greater than its speed of rotation multiplied by its diameter. A method for measuring the slipping is known, for example by comparing the speed of rotation of the wheel (measured with the wheel speed sensor-WSS) with the vehicle speed.

According to a particular embodiment of the emergency braking method, the reducing operation is a multiplication by a multiplying coefficient.

According to a particular embodiment of the emergency braking method, the multiplying coefficient is between 0 and 1, for example substantially equal to 0.84.

According to a particular embodiment of the emergency braking method, the multiplying coefficient is calculated using the maximum steering angle and the minimum steering angle, by applying the following formula: coefficient=sin[maximum steering angle]/sin[minimum steering angle].

According to a particular embodiment of the emergency braking method, the multiplying coefficient is determined as the vehicle moves, taking into account the real steering angle, by applying the following formula: coefficient=sin[real steering angle]/sin[minimum steering angle]. To apply this formula, the angle of rotation of the steering wheel in real time, as well as the vehicle width and the wheel speed, must be known. Document WO202099768 A1 discloses the formula to be used to determine the speed of the rear wheel. This formula is given below to explain how the content of this document is incorporated in the present description:

$${V}_{eAR} = ( \frac{\text{?}}{3} + \frac{2}{3} \frac{{V}_{min}^{2}}{{V}_{max}} ) {K}_{corr} .$$

$$\text{?} \text{indicates text missing or illegible when filed}$$

where V_{eAR} is the evaluation of the rear wheel speed, Vₘᵢₙ and Vₘₐₓ the evaluations of the front wheel speeds where

$${V}_{min} \leq {V}_{max} , \text{?} = \frac{1}{2} ( {V}_{min} + {V}_{max} )$$

$$\text{?} \text{indicates text missing or illegible when filed}$$

and K_{corr} is a correction coefficient, where

$${K}_{corr} = 1 pour \frac{{V}_{max}}{{V}_{min}} \leq {S}_{1} , et {K}_{corr} \leq 1 pour \frac{{V}_{max}}{{V}_{min}} > {S}_{1}$$

S₁ being a fixed threshold.

According to a particular embodiment, the first axle is a rear axle and the second axle is a front axle. Preferably, the vehicle has exactly two axles.

Another object of the invention is a braking system, characterised in that it comprises means adapted to implement the method as described above.

Another object of the invention is a motor vehicle, characterised in that it comprises at least one braking system according to the invention.

### BRIEF DESCRIPTION OF THE FIGURES

The invention will be better understood on reading the accompanying figures, which are given solely by way of example and not limiting in any way, in which:

FIG. 1 is a schematic plan view of a motor vehicle,

FIG. 2 shows the vehicle of FIG. 1 on a trajectory,

FIG. 3 is a flowchart illustrating the steps of an implementation of the method on the vehicle.

### DETAILED DESCRIPTION

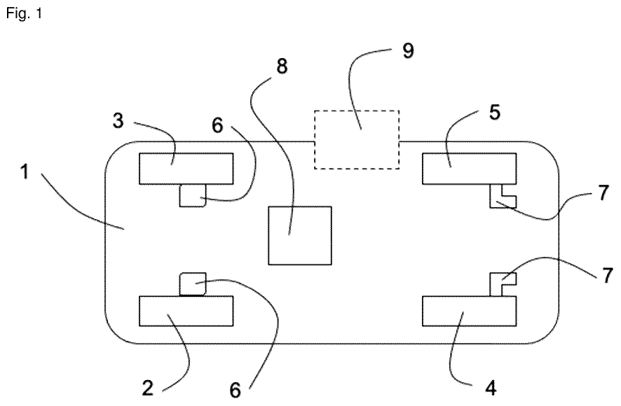

FIG. 1 shows a view from above of a vehicle 1 which comprises four wheels, i.e.:
two driving and steering front wheels 2, 3, one left front wheel 2 and one right front wheel 3, and
two non-driving and non-steering rear wheels 4, 5, one left rear wheel 4 and one right rear wheel 5.

In this case, each of the front wheels 2, 3 is equipped with a main service brake 6 controlled by the driver of the vehicle 1, and each of the rear wheels is equipped with a parking brake 7, adapted to operate as a parking brake and as an emergency brake. Each parking brake 7 has an electric motor (not shown) controlled by an engine control unit 8 using information concerning certain parameters of the vehicle 1 and its driving state. The engine control unit 8 is active when emergency braking becomes necessary or parking is requested.

Each main brake 6 is used, during normal operation of the vehicle 1, to slow down the latter when requested by the driver, by actuating a hydraulic brake control. The hydraulic brake system is provided with control means which will not be described here.

In the event of failure of the hydraulic brakes or of their control means, computing means 9 allow emergency switching to electric braking by the parking brakes. These computing means 9 can be centralised on the vehicle 1 or specific to the brake system.

Each parking brake 7 can be used according to two operating modes by the engine control unit 8: RWU mode (Rear Wheel Unlocker) or IFA mode (Incremental Force Actuation or Incremental Force level Application).

RWU mode uses two slipping thresholds, a first threshold (or low threshold) and a second threshold (or high threshold). These thresholds can be set to average values so that they are suitable for any type of vehicle 1. They can also be calibrated by type of vehicle 1, or even by model of vehicle 1. For example, the low threshold can be set to zero, which means that as soon as one wheel has a speed that is strictly less than the reference speed, it is considered to be slipping on the ground.

These two operating modes, defined previously, will not be described here since they are well known to those skilled in the art.

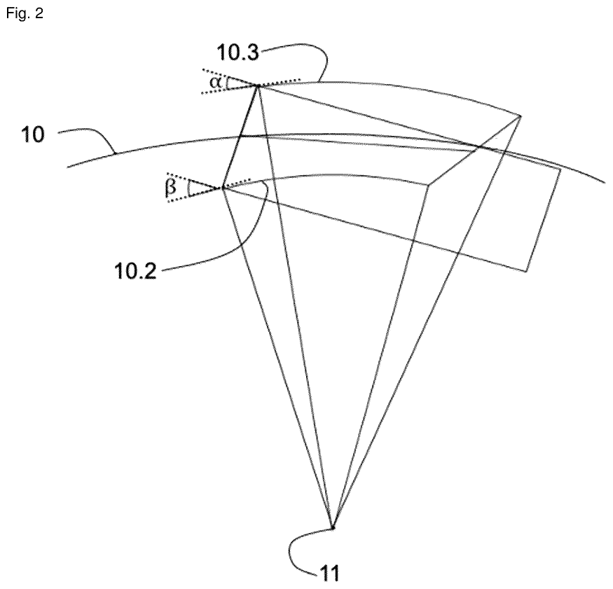

FIG. 2 shows a portion of the trajectories of the vehicle 1 and of the left and right front wheels 2, 3.

The vehicle 1 is globally following a curved trajectory 10. For each front wheel, this curved trajectory results in a specific trajectory 10.2, 10.3, which in this case is similar to a portion of a circle of centre 11.

The radius of curvature of the portion of circle is smaller for the wheels on the inside, in this case the left wheels, than for the wheels on the outside, in this case the right wheels.

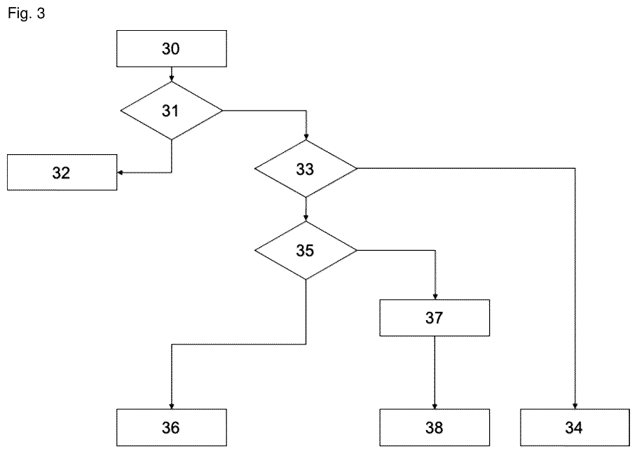

The steering radius of the front wheels 2, 3 is represented by the angles alpha and beta, measured at the tangent of the trajectory, substantially at the point of contact of the wheel with the ground. By construction of the vehicle 1, the steering angle of the wheel on the inside of the bend, the left front wheel 2 on FIG. 3, is greater than the steering angle of the wheel on the outside of the bend, in this case the right front wheel 3.

Each wheel has its own speed of rotation. The speeds of rotation are designated as follows: V2 for the left front wheel 2, V3 for the right front wheel 3, V4 for the left rear wheel 4, V5 for the right rear wheel 5.

As shown on FIG. 3, when the driver executes a dynamic braking request (step 30), the computing means 9 start by checking (step 31) whether the main brakes 6 are operating correctly. If this is the case, traditional braking takes place (step 32).

Otherwise, the computing means 9 trigger emergency braking by the engine control unit 8, according to the algorithm shown on FIG. 3.

During step 33, the computing means 9 check whether at least one of the two front wheels 2, 3 is supplying its own speed. In the event of failure to deliver the speed of rotation of the two front wheels 2, 3, in other words no front wheel speed is known, the method moves to step 34 of incremental braking.

Otherwise, during step 35, the computing means 9 check whether the two front wheels 2, 3 are supplying their speeds. In the affirmative, anti-lock braking takes place in step 36 with a reference speed calculated using the speeds of the two front wheels 2, 3, according to the emergency braking method of the state of the art.

Otherwise, one of the front wheels 2, 3 is supplying its speed, but not the other. The method then moves to step 37 of correcting the only known speed.

The only front wheel speed supplied without failure is therefore corrected by applying a reducing operation to supply a corrected reference speed.

The reducing operation may consist of a multiplication by a multiplying coefficient, whose value is less than 1. This coefficient can be set beforehand once and for all, to a value adapted to be suitable for any type of vehicle 1. According to the calculations and tests conducted by the inventors, the value 0.84 seems to be optimum as a universal coefficient.

The coefficient can also be calculated according to the model of vehicle 1, using its known geometric parameters.

For example, using the maximum steering angle (that of the wheels on the inside), the minimum steering angle (that of the wheels on the outside), a coefficient can be determined by applying the following formula:

coefficient=1/sin[maximum steering angle]/sin[minimum steering angle] where the minimum steering angle and the maximum steering angle are chosen from alpha and beta depending on the direction of the bend (right hand bend or left hand bend).

Lastly, the coefficient can also be determined while the vehicle 1 is moving, taking into account the real steering angle, by applying the following formula:

coefficient=1/sin[real steering angle]/sin[minimum steering angle] where the minimum steering angle is chosen from alpha and beta depending on the direction of the bend (right hand bend or left hand bend).

This corrected speed is then compared, during step 38, with the speed of each of the rear wheels 4, 5 to apply braking in RWU mode of the rear wheels 4, 5, which takes this corrected speed as reference speed.

The invention is not limited to the embodiments described and other embodiments will be clearly apparent to those skilled in the art.

### LIST OF REFERENCES

1 . . . Vehicle
2 . . . Left front wheel
3 . . . Right front wheel
4 . . . Left rear wheel
5 . . . Right rear wheel
6 . . . Main brake
7 . . . Parking brake
8 . . . Engine control unit
9 . . . Computing means
10 . . . Curved trajectory
10.2 . . . Left front wheel specific trajectory
10.3 . . . Right front wheel specific trajectory
11 . . . Centre
31 . . . Checking step
32 . . . Traditional braking
33 . . . Checking step
34 . . . Incremental braking
35 . . . Checking step
36 . . . Anti-lock braking
37 . . . Step of correcting the reference speed
38 . . . Comparison step

1. A method for emergency braking of a vehicle wheel equipped with an electric parking brake, the vehicle having at least two axles and the wheel being on a first of said at least two axles, by implementing either an anti-lock braking mode, or an incremental braking mode, the anti-lock braking mode being provided by controlling the parking brake in compliance with the following rules, whereas slipping of the wheel is obtained by calculating a difference between a speed of rotation of the wheel and a reference speed obtained using a speed of at least one of the two wheels of a second of said at least two axles of the vehicle:
if the slipping is less than a first predetermined threshold, progressively applying the brake until the slipping becomes greater than this first threshold,
if the slipping is greater than a second predetermined threshold, greater than the first threshold, progressively releasing the brake until the slipping becomes less than this second threshold,
if the slipping is greater than the first threshold and less than the second threshold, maintaining application at its current level,
the incremental braking method being provided by controlling the parking brake by increasing its application in stages of predetermined durations, the method being characterised in that, when the speeds of the two wheels of the second axle are not known but only one is known, the anti-lock braking mode is applied with, as reference speed, this known speed,
corrected by a reducing operation, and when the speed of no wheel on the second axle is known, the incremental braking mode is applied.

2. The method for emergency braking according to claim 1, wherein the reducing operation is a multiplication by a multiplying coefficient.

3. The method for emergency braking according to claim 2, wherein the multiplying coefficient is between 0 and 1.

4. The method for emergency braking according to claim 2, wherein the multiplying coefficient is calculated using a maximum steering angle and a minimum steering angle, by applying a following formula:
coefficient=1/sin[maximum steering angle]/sin[minimum steering angle].

5. The method for emergency braking according to claim 2, wherein the multiplying coefficient is determined as the vehicle moves, taking into account a real steering angle, by applying a following formula:
coefficient=1/sin[real steering angle]/sin[minimum steering angle].

6. The method for emergency braking according to claim 1, wherein the first axle is a rear axle and the second axle is a front axle.

7. A braking system, characterised in that it comprises means adapted to implement the method according to claim 1.

8. A motor vehicle, characterised in that it comprises at least one braking system according to claim 7.

9. The method for emergency braking according to claim 3, wherein the multiplying coefficient is substantially equal to 0.84.

10. The method for emergency braking according to claim 6, wherein the vehicle has exactly two axles.

11. The method for emergency braking according to claim 3, wherein the multiplying coefficient is calculated using a maximum steering angle and a minimum steering angle, by applying a following formula:
coefficient=1/sin[maximum steering angle]/sin[minimum steering angle].

12. The method for emergency braking according to claim 11, wherein the multiplying coefficient is determined as the vehicle moves, taking into account a real steering angle, by applying a following formula:
coefficient=1/sin[real steering angle]/sin[minimum steering angle].

13. The method for emergency braking according to claim 12, wherein the first axle is a rear axle and the second axle is a front axle and the vehicle has exactly two axles.

14. A braking system, characterised in that it comprises means adapted to implement the method according to claim 13.

15. A motor vehicle, characterised in that it comprises at least one braking system according to claim 14.
